(19) United States
(12) Patent Application Publication
(10) Pub. No.: US 2009/0284584 A1
(43) Pub. Date: Nov. 19, 2009

(54) IMAGE PROCESSING DEVICE

(75) Inventors: Yasutaka Wakabayashi, Chiba-shi (JP); Ryuji Kitaura, Chiba-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 12/296,252

(22) PCT Filed: Oct. 10, 2006
(86) PCT No.: PCT/JP2006/320202

§ 371 Date: Apr. 6, 2009

(30) Foreign Application Priority Data
Apr. 7, 2006 (JP) 2006-106386

(51) Int. Cl. H04N 13/00

(52) U.S. Cl. 348/44; 348/E13.001

(57) ABSTRACT

To provide an image processing device which, when synthesizing an image into a 3D image, realizes image synthesis free from artifacts by taking parallax of 3D image into consideration, and suppresses deterioration of image quality at block encoding. An image processing device 1 receives a left-eye image obtained from the viewpoint corresponding to the left eye and a right-eye image obtained from the viewpoint corresponding to the right eye as input, determines the transparency of an object to be synthesized into the left-eye image and right-eye image by transparency determining means 3, based on the parallax information from a parallax detecting means 2 that detects parallax information and the positional information from a positioning means 5, and further determines the synthesized position of the object by an adjusting means 32 so that it aligns with the boundaries of encoding blocks, to thereby achieve synthesis of the object into the left-eye image and right-eye image.

### TECHNICAL FIELD

The present invention relates to an image processing device in which visible attribute information is added to image data when image data for 3-dimensional display is created.

### BACKGROUND ART

Conventionally, various methods for displaying stereoscopic images have been proposed. Of these, the generally used method is called the “binocular method” that uses binocular parallax. This method enables a viewer to have stereoscopic vision as if he/she is directly looking at a subject, by preparing the image for the left eye and the image for the right eye having binocular parallax (which will be referred to hereinbelow as “left-eye image” and “right-eye image” respectively) and making the viewer see the left-eye image through the left eye and the right-eye image through the right eye.

As the creating methods for a stereo image in stereovision, two methods called the cross-eyed and parallel viewing methods have been known. Left and right-eye images for creating a stereo image are taken by placing cameras at the positions corresponding to left and right viewpoints. Alternatively, the image can be prepared by placing pseudo-cameras in software at the viewpoints corresponding to left and right viewpoints. Then, the taken left and right-eye images are used in such a manner that the left-eye image is placed on the left-hand side and the right-eye image is placed on the right-hand side in the parallel method, whereas the left-eye image is placed on the right-hand side and the right-eye image is placed on the left-hand side in the cross-eye method.

In recent years, display devices which enable an electronic stereo image consisting of the left-eye image and right-eye image to be viewed in a stereovision with the naked eye or through special glasses have been proposed. Examples of typical schemes of binocular methods include the time division scheme, the parallax barrier scheme and the polarization filter scheme and the like. Of these, the parallax barrier scheme will be described as an example.

FIG. 14 is a conceptual view for illustrating the parallax barrier scheme. FIG. 14(a) is a view showing the principle of the cause of parallax. FIG. 14(b) is a view showing an image screen displayed in the parallax barrier scheme.

In FIG. 14(a), an image in which one-pixel stripes of the left-eye image and the right-eye image are arranged alternately in the horizontal direction as shown in FIG. 14(b), is displayed on an image display panel 50 while a parallax barrier 51 with slits arranged at intervals of a distance smaller than the distance between the pixels for the same point of view is placed in front of image display panel 50, so that the viewer will view the left-eye image only through left eye 52 and the right-eye image only through right eye 53 so as to be able to have a stereovision.

Herein, one example of a recording data format corresponding to the parallax barrier scheme is shown in FIG. 15. Based on the left-eye image shown in FIG. 15(a) and the right-eye image shown in FIG. 15(b), each image is thinned by removing every other strip of one pixel in the horizontal direction to create and record a single stereo image shown in FIG. 15(c). When it is displayed, every pixel of this stereo image is rearranged so that the viewer can view a stereovision with the naked eye through a display device that supports the parallax barrier scheme or lenticular scheme.

Though the configuration such as the pixel layout and the like of the left-eye and right-eye images may be made different depending on each stereoscopic scheme, the image for binocular stereoscopic vision is mostly given in a format in which the left-eye image and the right-eye image are arranged side by side as shown in FIG. 15(c).

Concerning this stereo image, there is a demand for synthesizing images, characters and the like. For example, when the stereo image is displayed on an ordinary display device that does not support stereovision, the result is one where the left-eye image and the right-eye image are merely displayed side by side. In this case, for those who merely own an ordinary display device, it is impossible to clearly distinguish the fact that the data is taken for stereovision, possibly giving rise to confusion. To deal with this, there has been proposed a method for taking a stereograph by taking the patterns that represent the identification information for which recorded images are the left-eye image and the right-eye image and also a common pattern in the left-eye and right-eye images for assisting the stereovision corresponding to the picture taking method, within the film (see patent document 1)

Similarly, also in the case of stereo image data to be displayed on the display device, it is possible to clarify that the data is for a stereo image, by synthesizing such marks.

There has been also disclosed a method of writing arbitrary characters and the like into a stereo image. For adjustment of the depth of the arbitrary input characters etc., there is a button for making the perspective position of these characters etc. closer or more distant so that the user can arbitrarily adjust the depth through the button (see patent document 2).

There is also the problem that, when image synthesis is simply performed for the purpose of the aforementioned image synthesis, degradation of image quality occurs when a compression encoding process is performed. As a measure to avoid this, a method which limits the position where the synthesized image should be laid out, based on the block size when compression encoding is carried out, has been disclosed (see patent document 3).

Further, a method for adjusting the size of the unit pixels that constitute the character image data to be synthesized, to the size that is obtained by dividing the block size for block encoding by an even number or by multiplying the block size by an integer, has been disclosed (see patent document 4).

Patent document 1:

Japanese Patent Application Laid-open Hei 06-324413

Patent document 2:

Japanese Patent Application Laid-open 2004-104331

Patent document 3:

Japanese Patent Application Laid-open Hei 07-38918

Patent document 4:

Japanese Patent Application Laid-open Hei 08-251419

### DISCLOSURE OF INVENTION

### Problems to be Solved by the Invention

However, if such synthesis is made without consideration of the parallax in the stereograph, it may cause the viewer to feel fatigued due to difficulty when viewing. For example, when an image that pops out when viewed in stereovision is combined with an image that is seen on the display screen without imparting any parallax, only the synthesized image area will appear in the background relative to the surrounding area, possibly causing an uncomfortable feeling and imparting fatigue.

The present invention has been devised to solve the above problems, it is therefore an object of the present invention to provide an image processing device which, when synthesizing an object such as an image into stereo image data, achieves synthesis by suppressing influence on image quality under consideration of parallax.

### Means for Solving the Problems

The present invention is an image processing device for creating stereo image data composed of a plurality of images corresponding to a plurality of viewpoints, comprising: an image synthesizing means for synthesizing an object into the stereo image data; and a transparency determining means for designating a transparency of the object, characterized in that the transparency determining means determines the transparency of the object based on parallax information between the plurality of images corresponding to the plurality of viewpoints.

Further, the device is further characterized in that the transparency determining means acquires, as the parallax information, a parallax between areas in the plurality of images corresponding to the plurality of viewpoints, into which the object is synthesized, and sets the transparency of the object based on the parallax information.

The device is also characterized in that the transparency determining means takes a difference value between the amount of parallax between the areas in the images into which the object is synthesized and the amount of parallax as to the object, and determines the transparency based on the difference value.

The device further includes: a positioning means for determining a position of the object, and is characterized in that the positioning means detects an occlusion area where no corresponding point exists based on the parallax information on the images and determines the position of the object so that the object overlaps the occlusion area.

The device is also characterized in that the image synthesizing means, based on the parallax information on the areas in the images into which the object is synthesized, synthesizes the object to each of the images in such a manner that the amount of parallax of the object becomes closest to the amount of parallax of the parallax information.

Also, the device is characterized in that the image synthesizing means, based on the parallax information on the areas in the images into which the object is synthesized, determines a horizontal position of the object such that the amount of parallax of the object is greater than the amount of parallax of the parallax information and a left edge of the object or a right edge of the object coincides with the boundary of encoding blocks.

Further, the device is characterized in that the image synthesizing means, when the object is synthesized into the images, synthesizes the object so that a lower or upper boundary of the object with respect to a vertical direction and a left or right boundary with respect to a horizontal direction coincides with boundaries of encoding blocks.

Moreover the device is characterized in that both vertical and horizontal dimensions of the object are each equal to an integer multiple of the encoding block.

Also, the device is characterized in that the object is a visible, stereo image identification information that includes information indicating a stereo image.

### ADVANTAGE OF THE INVENTION

According to the image processing device of the present invention, the device includes: an image synthesizing means for synthesizing an object into the stereo image data; and a transparency determining means for designating a transparency of the object, and is characterized in that the transparency determining means determines the transparency of the object based on parallax information between the plurality of images corresponding to the plurality of viewpoints. Accordingly, when an object is synthesized into an stereo image, it is possible to prevent the object from hindering stereovision and causing uncomfortable feeding.

Further, it is possible for the transparency determining means to acquire, as the parallax information, a parallax between areas in the plurality of images corresponding to the plurality of view points, into which the object is synthesized, and set the transparency of the object based on the parallax information. Accordingly, by use of this means, even when an object is synthesized into a stereo image by placing the object in the area in which the original stereo image appears in front of the object, the original stereo image becomes able to be seen through the object by setting up a transparence for the area where it has parallax in the stereo image, it is hence possible to achieve synthesis without causing uncomfortable feeling.

Also, the transparency determining means takes a difference value between the amount of parallax between the areas in the images into which the object is synthesized and the amount of parallax as to the object, and modifies the transparency based on the difference value, whereby it is possible to prevent occurrence of uncomfortable feeling in an improved manner, by, for example, increasing the transparency the greater in the area where it has a greater amount of parallax hence the greater unconformable feeling is expected.

Further the image synthesizing means detects an occlusion area where no corresponding point exists based on the parallax information on the images and synthesizes the object so as to overlap the occlusion area, whereby the occlusion area which hinders stereovision is made obscure, thus making it possible to reduce uncomfortable feeling.

The object is synthesized into the images by using the image synthesizing means in such a manner that, based on the parallax information on the areas in the images into which the object is synthesized, the amount of parallax of the object becomes closest to the amount of parallax from the parallax information. It is hence possible to keep the amount of parallax in the image after synthesis equivalent to that before synthesis.

By use of the image synthesizing means, the object is positioned based on the parallax information on the areas in the images into which the object is synthesized so that the object appears in front of the image, and a horizontal position of the object is determined so that a left edge of the object or a right edge of the object coincides with a boundary of encoding blocks. Accordingly, when the object is synthesized so that it appears in front of the display screen, the object is synthesized so that it appears at the most front position, whereby it is possible to prevent the object from being seen at a position more interior than the stereo image, hence reduce unconformable feeling or fatigue of the viewer.

Further, when the object is synthesized into the images using the image synthesizing means, the object is synthesized so that a lower or upper boundary of the object with respect to a vertical direction and a left or right boundary with respect to a horizontal direction coincide with boundaries of encoding blocks, whereby, when encoding, it is possible to minimize the area where the object straddles the boundaries of the encoding blocks, hence reduce the amount of codes.

Also, by making both vertical and horizontal dimensions of the object equal to integer multiples of the encoding block, it is possible to avoid straddling of the object over the boundaries of encoding blocks, hence achieve efficient encoding.

Still more, when the object is a visible, stereo image identification information that includes information indicating a stereo image, even if this stereo image is displayed on a 2D display device, it is possible for the viewer to know the image is that for stereovision at a glance.

### BRIEF DESCRIPTION OF DRAWINGS

FIG. 1 is a block diagram showing a configuration of an image processing device of embodiment 1 of the present invention.

FIG. 2 is a view for illustrating the parallax of stereo image data.

FIG. 3 is a view for illustration of a parallax detecting method.

FIG. 4 is a view for illustration of a parallax detecting method.

FIG. 5 is a view relating object synthesis into stereo image data.

FIG. 6 is a view showing one example of stereo image data after object synthesis.

FIG. 7 is a view for illustration relating to blocks for block encoding.

FIG. 8 is a block diagram showing the procedures of block encoding.

FIG. 9 is a block diagram showing a configuration of an image processing device of embodiment 2 of the present invention.

FIG. 10 is a view showing one example of a 3D mark in stereo image data.

FIG. 11 is a view for illustration relating to a synthesizing method of an object into stereo image data.

FIG. 12 is a view for illustration relating to a synthesizing method of an object into stereo image data.

FIG. 13 is a conceptual view for illustrating a time-division scheme.

FIG. 14 is a conceptual view for illustrating a parallax barrier scheme.

FIG. 15 is a view for illustrating a recording data format in a parallax barrier scheme.

### DESCRIPTION OF REFERENCE NUMERALS

1,30 image processing device
2 parallax detecting means
3 transparency determining means
4 image synthesizing means
5 positioning means
6 encoding means
7L,8L point in the left-eye image
7R,8R point in the right-eye image
9 characteristic point
10,11 camera
12 epipolar plane
13,14 image plane
15, 16 epipolar line
17,18 block
19,35,40,41,42,43,44,45 object
20,21,36,37 image area
22 block image
23 DCT unit
24 quantizer
25 quantization table
26 entropy encoder
27 encoding table
31 3D information creating means
32 Adjusting means
33 Image synthesizing means
34 Multiplexing means
38,39,46 left/right boundary
50 image display panel
51 parallax barrier
52 right eye
53 left eye

### BEST MODE FOR CARRYING OUT THE INVENTION

### Embodiment 1

The embodiment of the present invention will be described with reference to the drawings. In the following description, “3D” is used as the term meaning three-dimensional or stereo and “2D” is used as the term meaning two-dimensional. Description will be made referring a three-dimensional or stereo image as “3D image” and an ordinary two-dimensional image as “2D image”.

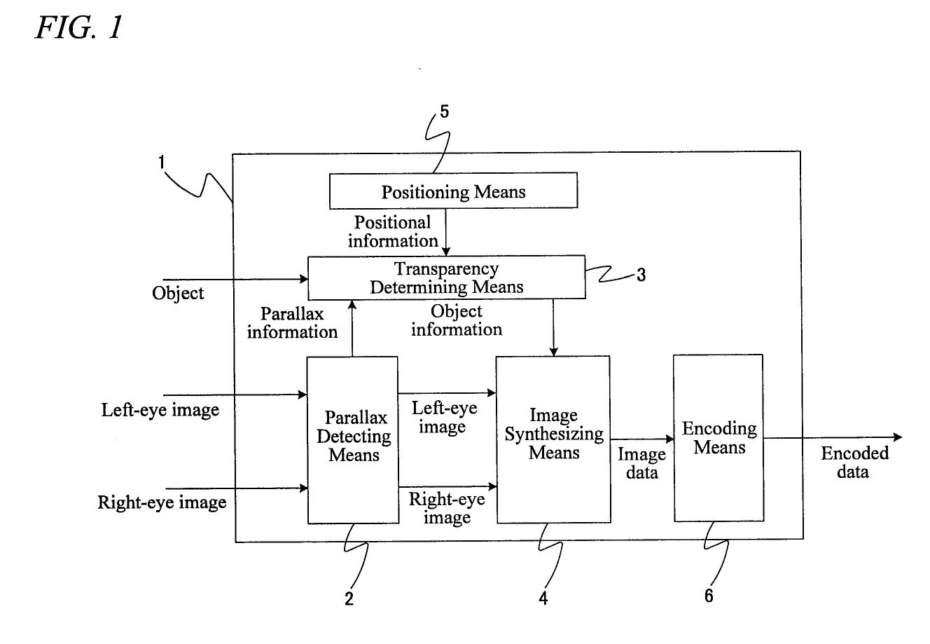

FIG. 1 is a block diagram showing the configuration of an image processing device of embodiment 1 of the present invention.

Image processing device 1 includes: a parallax detecting means 2 that receives a left-eye image obtained from a viewpoint corresponding to the left eye and a right-eye image from the right eye as input and detects parallax information; a transparency determining means 3 for determining the transparency of an object to be synthesized into an image made of the left-eye image and the right-eye image; an image synthesizing means 4 for synthesizing left-eye and right-eye images and the object; a positioning means 5 for determining the synthesized position of the object; an encoding means 6 for encoding the synthesized image; and means for accessing unillustrated recording media and communication lines.

In the present embodiment, the image prepared by this image processing device will be described assuming that it is displayed in a 3D display device based on a parallax barrier scheme, for example.

To begin with, when an image signal formed of the left-eye image and the right-eye image is input to image processing device 1, parallax detecting means 2 detects parallax information from the left-eye and right-eye images.

Parallax is detected by, for example, stereo matching. Stereo matching is used to compute which part of the right-eye image corresponds to the left-eye image by calculation of area correlation so as to determine the deviation between associated points as parallax.

When a 3D image is displayed on a 3D display device supporting 3D representation, the greater amount of parallax an object has, the more it appears to pop out from the display screen or the more to the rear it seems to be located from the display screen.

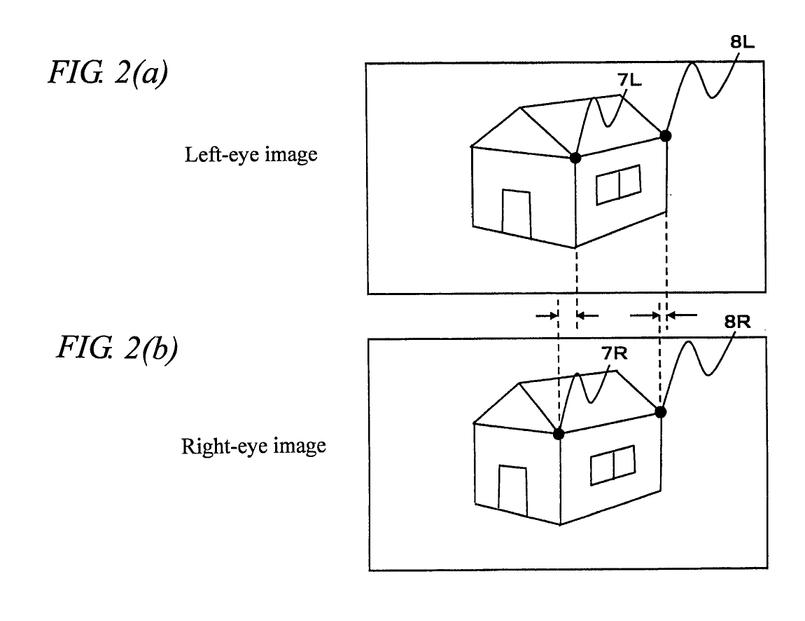

FIG. 2 is a view illustrating parallax. FIG. 2 shows photographed images of a house, the image of FIG. 2(a) being the left-eye image taken by the crossing method, the image of FIG. 2(b) being the right-eye image. It is assumed that the background has no parallax.

Here, when a corresponding point in the right-eye image on the basis of the left-eye image is located on the left side relative to that in the left-eye image, it appears to pop up, and when it is located on the right side, it looks more to the rear from the display screen. When there is no parallax, or when the point in the left-eye image and the point of right-eye image are located at the same position, these points appear at the position of the display screen.

For example, in comparison between the images 2(a) and 2(b), when the points on the right-eye image corresponding to points 7L and 8L in the left-eye image are denoted by 7R and 8R, respectively, the parallax between 7L and 7R which are located closer to the positions of the cameras that took the respective images becomes greater whereas the parallax between 8L and 8R which are located farther from the positions of the cameras becomes smaller. In this case, the corresponding points in the right-eye image on the basis of the left-eye image are shifted to the left side. Accordingly, 7L and 7R and 8L and 8R both appear to pop up from the display screen, but the point formed by 7L and 7R which have a greater amount of parallax is perceived to pop up more frontward, by the viewer, than the point formed by 8L and 8R.

Next, the method of detecting parallax information by stereo matching in the above parallax detecting means 2 will be described in detail.

The amount of parallax can be calculated by comparing the left-eye image and the right-eye image to determine the corresponding points of a subject. However, when the input image is regarded as a two-dimensional array having pixel values as the values at their points to determine the correspondence relationship between the points on the same line, the result becomes markedly unstable if comparison of the pixels is performed point-wise. To deal with this, an area correlation method is used to compare the pixels of interest in an area-wise manner such that differences at individual points in each area between the left and right images are calculated, and the combination of the points which minimize the total of the differences are determined as the corresponding points.

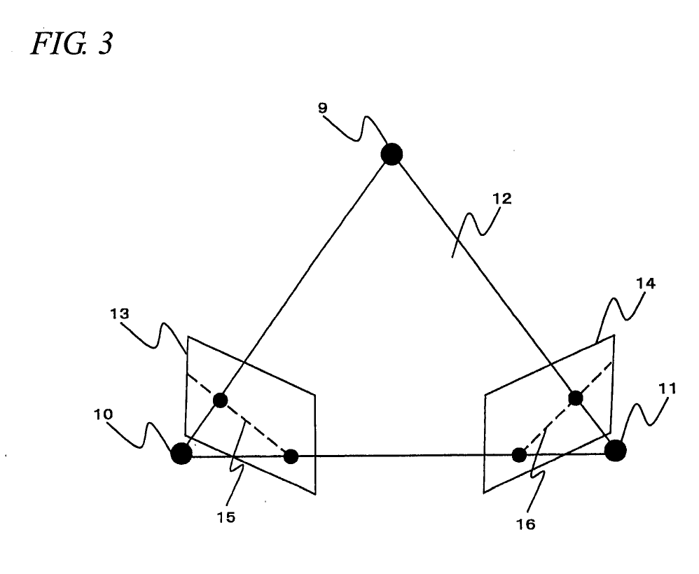

FIG. 2 shows this example. Here, since the epipolar lines coincide with each other, corresponding points can be located by shifting only the horizontal location with the vertical location fixed at the same height. As shown in FIG. 3, the epipolar lines are lines corresponding to the lines of intersection between a plane (epipolar plane) 12 that is defined by a characteristic point 9 in the space and the centers of the lenses of two cameras 10 and 11, and image planes 13 and 14 of the cameras, being represented by the broken lines at 15 and 16 in the drawing. Though, in FIG. 3, these lines do not coincide, in the images of the present embodiment in FIG. 2, the epipolar lines are made to coincide to each other by setting the cameras at the same height and parallel to the horizontal plane.

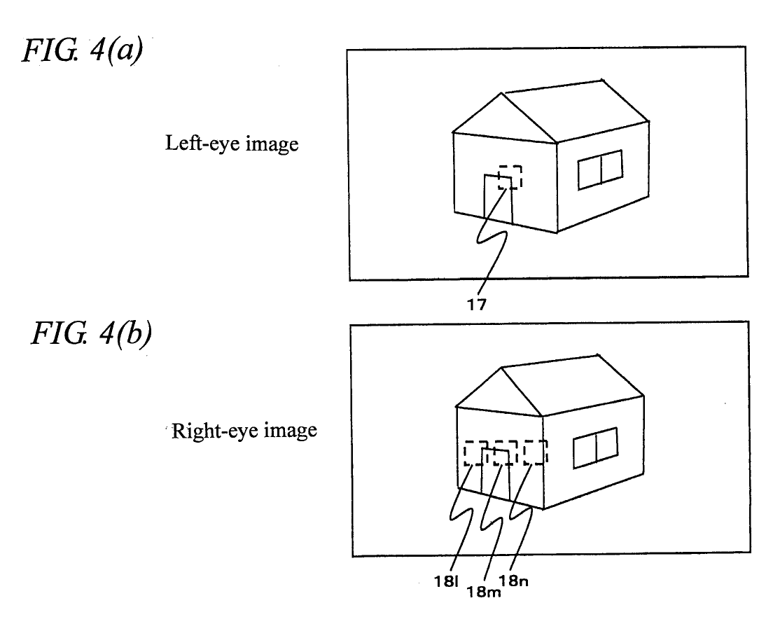

As shown in FIG. 4, corresponding points are located using block units of a certain fixed size. Comparison is made based on the differences in RGB (red, green, blue) components between associated pixels.

FIG. 4(a) is the left-eye image and FIG. 4(b) is the right-eye image. In these images, the pixels located at the x-th place in the lateral direction and y-th place in the vertical direction on the basis of the upper left pixel are assumed to be denoted as L(x,y) and R(x,y). As described above, since the locations in the vertical direction coincide, parallax is determined by comparison in the lateral direction only. When the amount of parallax is denoted as d, the differences in RGB components between the pixel values at L(x,y) and R(x−d,y) will be compared. This comparison is made for every block. For instance, when a block is formed of 4×4 pixels, pixel values on each of left and right images are compared as to sixteen pixels to determine their differences and the sum. The sum of the differences is used to check the degree of similarity between the blocks. When the sum of these differences becomes minimum, the pairs of blocks are regarded to correspond to each other, hence d at that time is obtained as the amount of parallax.

In FIG. 4, when the differences in RGB components of blocks 18l, 18m and 18n in FIG. 4(b) from block 17 in FIG. 4(a) are calculated as above, the difference becomes minimum with 18m, hence this block turns out to be the corresponding block and the amount of parallax d is determined. By dividing the whole image into blocks and locating the corresponding point for each, it is possible to calculate the amount of parallax for every block of the whole image.

In addition, though the difference in RGB components is checked for comparison in the above, each of the differences as to R, G and B may be weighted separately.

Further, the RGB components may be converted into the YUV components that give a representation with luminance and chromaticity or the like and the differences as to Y, U and V may be weighted separately. For example, the sum of the differences can be determined using the luminance component only.

Though in the above description, blocks of 4×4 pixels are used, the block may be formed of any number of pixels as long as it is formed of, at least, one block or more in both the vertical and horizontal directions.

Parallax detecting means 2 forwards the left-eye image and the right-eye image to image synthesizing means 4 and sends parallax information to transparency determining means 3. Transparency determining means 3 receives an object to be synthesized into the 3D image as input and determines the synthesized position of the object in accordance with the positional information from positioning means 5.

Here, for instance, the object is assumed to be a solid white rectangular pattern.

Positioning means 5 acquires positional information with regard to the placement position in the 3D image in accordance with, for example user instructions. For example, if this image processing device is a terminal device such as a PC (personal computer), the user will designate the placement position in the image by means of an input device such as a keyboard or mouse.

Alternatively, it is also possible to provide such a configuration that parallax information is input from parallax detecting means 2 to positioning means 5 and positioning means 5, based on the parallax information, determines the area where there is no corresponding point in the original 3D image, and disposes the object at the position that contains that area in the greatest proportion.

An area where corresponding points are hidden due to difference in viewpoint hence there is no corresponding point within the image is generally called an occlusion area, and this may hinder stereovision. However, when an object is arranged so as to overlap the occlusion area, the occlusion area becomes unlikely to be seen by the viewer, hence this enables the image to be seen more easily in stereovision.

Transparency determining means 3, based on the synthesized position of the object into the 3D image that is determined by the positional information, acquires the parallax information on the synthesized position of the object from parallax detecting means 2 and creates transparency information that indicates to what degree and what parts of the object are made transparent, based on the parallax information.

For example, when, in the 3D image, the placement position of an object and therearound has an amount of parallax which causes the area to be seen in front of the display screen, if the object is synthesized into the left-eye image and right-eye image so that its parallax will be zero, in the stereovision of the image the object appears at the position of the display screen and the area around the object appears to pop up forwards, resultantly the image becomes unnatural and hard to view.

In order to solve this problem, referring first to the parallax information on the area where the object is placed in the original 3D image, the area is divided into area P1 where the original 3D image is displayed in front of the object and area P2 where it is not. That is, of the area to be handled, the area where the value obtained by subtracting the amount of parallax of the object from the amount of parallax of the original stereo image determined by the parallax information is greater than 0 and equal to or smaller than 0 are classified as P1 and P2, respectively.

Next, transparency determining means 3 determines the transparency of the object for each of the areas separated as above. For example, the transparency of the object in area P1 may be set at 50 percent and the transparency of the object in area P2 may be set at 0 percent, to thereby create transparency information. With this setting, the object will appear see-through in area P1 while in area P2, only the object will be observed.

Also, there is a case such that no corresponding point exists in the left-eye image and in the right-eye image. As to such area, the transparency of the object may be lowered or the object may be set to be opaque. In the present embodiment, the transparency information is created with the transparency of such area set at 20 percent, for example.

Transparency determining means 3 creates information including the aforementioned transparency information, the object and information on its placement position (which will be referred to hereinbelow as “object positional information” as object information, and sends it to image synthesizing means 4.

Image synthesizing means 4, based on the left-eye image and right-eye image obtained from parallax detecting means 2 and the transparency information, the object and object positional information included in the object information obtained from transparency determining means 3, performs image synthesis.

First, the method of synthesizing an object to each of the left-eye image and the right-eye image will be described using the drawings.

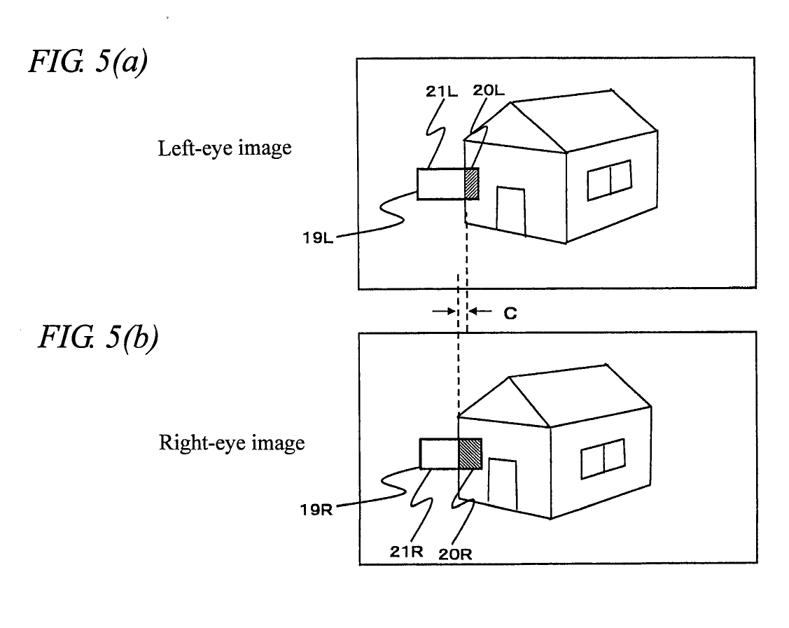

FIG. 5 is a view when an object is synthesized into each of the left and right-eye images. Designated at 19L is the object synthesized in the left-eye image, and 19R designates the object synthesized in the right-eye image. It is assumed that the position of the object from the upper left in each image is the same position as that in the other, hence there is no parallax with the object. It is assumed that in the 3D image of the left-eye image and the right-eye image, the background has no parallax and the area with a house has some parallax. Concerning the hatched end areas 20L and 20R where objects 19L and 19R overlap the house, since the left-side boundary of 20R exists on the left side of 20L as indicated with C, the hatched areas present such parallax that the part in the original image to which the object is synthesized is seen in the front side by the viewer while the non-hatched areas 21L and 21R in objects 19L and 19R present no parallax because they are the background.

Image synthesizing means 4 sets up the transparency of the object based on the transparency information included in the object information.

For example, when areas 20L and 20R in which the original 3D image is displayed in front of the object when the image is viewed in stereovision are designated to have a transparency of 50% by the transparency information, the object is synthesized in the original 3D image in accordance with the above information and the original 3D image appears in a see-through manner in front of the object.

Here, the transparency of the object is set at n % (0≦n≦100), image synthesis of the object and the original image is carried out in the ratio of (100−n) %:n %. That is, if the transparency of the object is 0%, only the object will be seen. As the setup method of the ratio for synthesizing, the pixels at the same position may be simply weighted in the ratio as described above, or other known methods can be used. Detailed description is omitted since it is not related to the present invention.

Further, when the transparency determining means which receives information relating to the area (occlusion area) having no other corresponding point, designates, for example, the transparency of the occlusion area at 20 percent and the transparency of the other area at 0 percent as the transparency information, the object is synthesized into the original 3D image in accordance with the information in such a manner that among the area where the paired objects overlap, the object is made opaque in the area where the original 3D image appears as the background of the object in stereovision while the object is displayed with a transparency of 20% as designated above because the occlusion area has no parallax hence it is impossible to determine whether the occlusion area is located in the background of or in front of the object.

In this way, the occlusion becomes difficult to see for the viewer by lowering the transparency of the object when it is synthesized into the occlusion area, thus making the image easier to see in stereovision.

When the synthesized image, thus obtained by the above synthesizing process is displayed in the 3D display device though the reproducing means, even the area where the original 3D image and the object overlap each other can be naturally seen in stereovision and the object itself can also be observed.

Thereby, even if the object, positioned with zero parallax, is synthesized in the stereo image, it is possible to steer clear of any unnatural appearance of the object relative to its surroundings, hence giving no uncomfortable feeling.

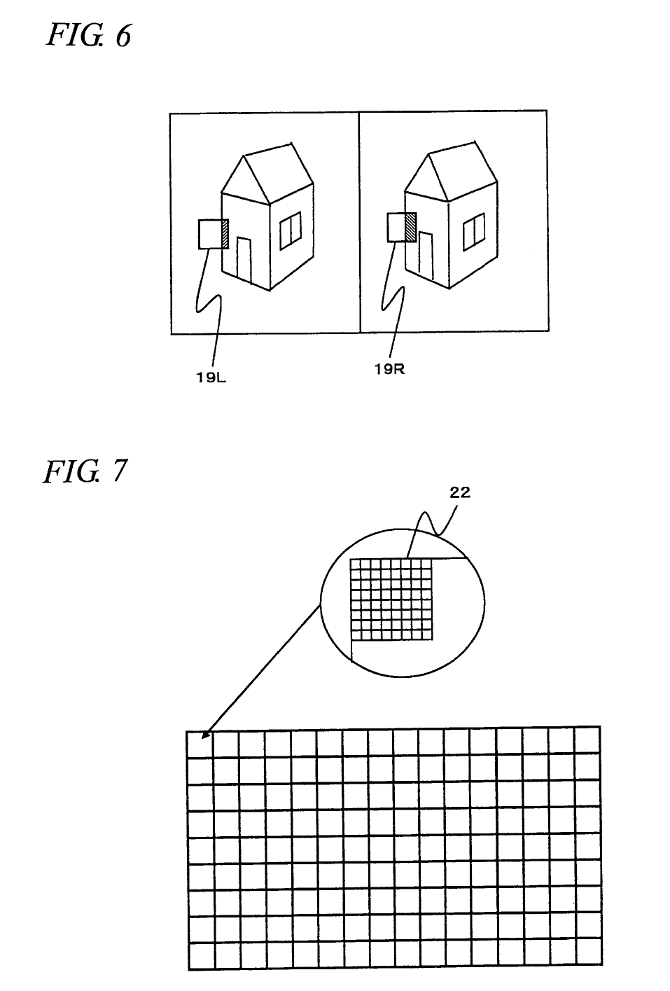

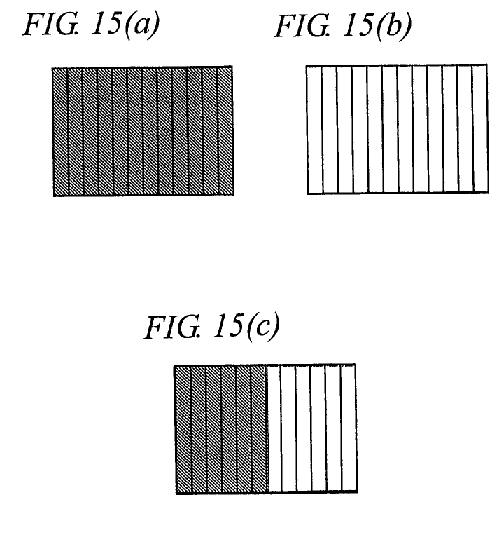

When the display device is, for example a 3D display device based on the parallax barrier scheme, the synthesized image output from image synthesizing means 4 takes the form of a joined image of the left and right images as shown in FIG. 15(c) that are obtained by removing every other strip of one pixel in the horizontal direction from each of the left and right viewpoint images. FIG. 6 shows an example of an image after synthesis.

The image data created by image synthesizing means 4 is forwarded to encoding means 6. Encoding means 6 performs encoding to compress the image data. Herein, JPEG (Joint Photographic Expert Group) is used as the image encoding scheme. In JPEG, the image is divided into small square blocks, which are expanded through an orthogonal transformation into a sum of a plurality of normal images that are orthogonal to each other, so as to encode the coefficients of the normal images. As the orthogonal transformation, DCT (discrete Fourier transform) is used.

In encoding means 6, the input image is split into a plurality of blocks as shown in FIG. 7, each block being made up of 8×8 pixels as shown in a block 22 in an encircled enlarged view.

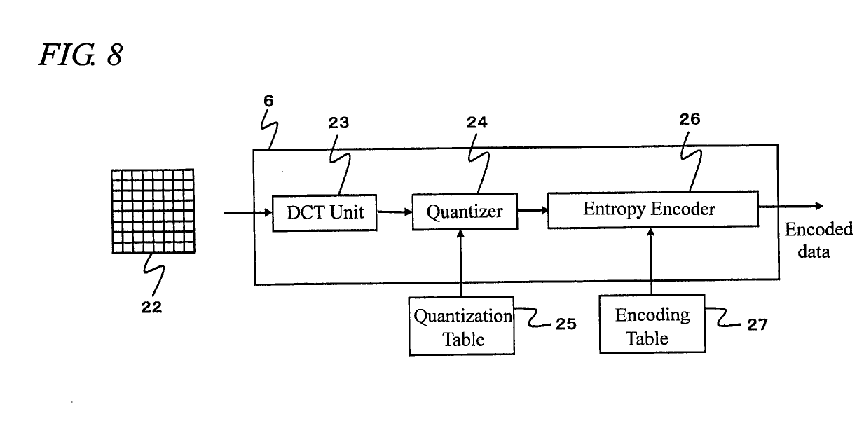

Encoding means 6 performs image encoding for each block, following the flow shown in FIG. 8.

To begin with, block 22 undergoes a two-dimensional DCT transformation by DCT unit 23. With this process, the block is divided into frequency components, then a quantizer 24, referring to a quantization table 25, divides each coefficient after DCT transformation by a divider based on quantization table 25 and rounds the remainder to discard high-frequency terms. An entropy encoder 26 performs encoding, using, for example Huffman encoding with reference to encoding table 27, and outputs a 3D image as the encoded data.

The encoded data is decoded by a reproducing means in a reverse process to the above and sent to the display device where it is displayed. Herein, the data is sent to the 3D display device. Since the transparency of the 3D image to be displayed was designated when it was image-synthesized, the image after image synthesis can be viewed in stereovision without any increase in uncomfortable feeling and fatigue.

Here, in the present embodiment, the image was assumed to be prepared by taking the left-eye and right-eye images in the crossing method, but it may be prepared using the parallel viewing method. Also, though the image was assumed to be JPEG, other imaging formats such as GIF (Graphic Interchange Format), PNG (Portable Network Graphics) and TIFF (Tagged Image File Format) may be used. The configuration of the encoding means 6 in FIG. 1 is changed depending on each format. A movie such as Motion-JPEG may also be used.

Further, there are various types of parallax detecting means 2 other than that described above, including those improved from the above, those using complex systems, etc., and any type can be used. When parallax information such as a parallax map etc., has been known previously without necessity of detecting parallax from the image, the information may be simply used.

Additionally, though the transparency of the object was specified at 50 percent or 20 percent for description, it is not limited to these and may be set to be either lower or higher, e.g., 80 percent.

Further, in the above example, the object was synthesized on assumption that the amount of parallax of the object was zero. However, the object may have some parallax. Even if some parallax is given, synthesis can be done in the same manner.

Also, parallax detecting means 2 may be set up such that it is given positional information from positioning means 5 in advance and perform parallax detection only for the area which the object overlaps.

Though in the present embodiment, the transparency is set up only for the area where the object overlaps the area having parallax, the object as a whole may be made transparent, and the transparency may be set not only for the image that is located in front of the display screen but also for the image that is located to the interior side. In addition, though the object was specified to be a rectangular pattern, but it may be, for example a mouse cursor or pointer etc.

Moreover, though the synthesizing method for the case where the area in the original 3D image into which an object is synthesized has parallax or for the case where synthesis is done for the occlusion area in which no corresponding point exists, was described, there is also a method of synthesizing an object by letting positioning means 5 search areas having no parallax or locations in which a large proportion of area has no parallax, based on the parallax information on the original 3D image, determining the placement of the object from the above areas and adding transparency information with arbitrary transparency by transparency determining means 3.

### Embodiment 2

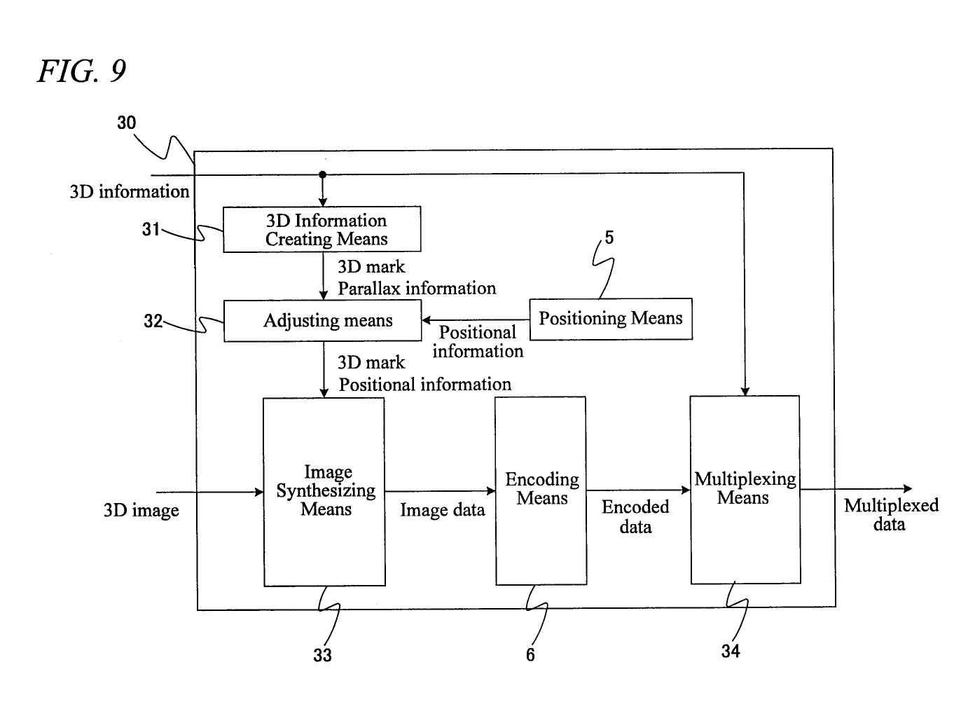

FIG. 9 is a block diagram showing a configuration of an image processing device of embodiment 2 of the present invention. Here, the components having the same functions as the above embodiment will be allotted with the same reference numerals.

An image processing device 30 includes: a 3D information creating means 31 that receives as its input 3D information including identification information as an indicator of a stereo image, information on the stereo image creating method, parallax information, etc., and creates as an object a 3D mark that gives knowledge of a stereo image in a visually recognizable manner; a positioning means 5 for outputting positional information when the aforementioned 3D mark is synthesized; an adjusting means 32 that receives the 3D mark and the parallax information from the aforementioned 3D information creating means 31 and the positional information from positioning means 5 to adjust the synthesized position of the 3D mark etc., based on these; an image synthesizing means 33 for performing image synthesis based on the 3D mark and positional information supplied from adjusting means 32 and a 3D image consisting of a left-eye image corresponding to the left-eye viewpoint and a right-eye image corresponding to the right-eye viewpoint supplied from an unillustrated input means; an encoding means 6 for encoding the synthesized image; a multiplexing means 34 for outputting image data and 3D information after multiplexing; and means for accessing unillustrated recording media and communication lines.

In the present embodiment, as one example, the image prepared by this image processing device 30 will be described assuming that it is displayed in a 3D display device based on a parallax barrier scheme.

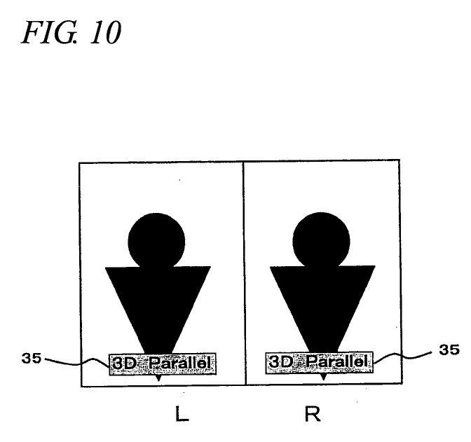

An image having a left-eye image and a right-eye image synthesized left and right and 3D information multiplexed is inverse-multiplexed by an unillustrated inverse-multiplexer so as to separate the image data and the 3D information, which are supplied to image processing device 30. The inverse multiplexing function may be included in the present image processing device. Of these, 3D information is input to 3D information creating means 31. The 3D information is assumed to consist of identification information as an indicator of a stereo image, a classification information showing the method of photographing, and a parallax map that represents parallax information. 3D information creating means 31 creates an image that enables a user to visibly check the information on 3D such as the entity of a stereo image, how the image was taken and the like. This is called a 3D mark, which is the object to be image synthesized in the present embodiment. FIG. 10 shows a synthesized image example when a 3D mark was synthesized.

Areas 35 indicating “3D Parallel” in the image as shown in FIG. 10 are the 3D mark. “3D” indicates the entity of a stereo image and “Parallel” indicates that this image was created based on the parallel viewing method. As a character string for indicating a stereo image, for example “Stereo”, “Stereo Photograph”, “Stereo Image” and the like can be used other than “3D”. As a character string representing the classification of the creating method, if it is the crossing method, for example “Crossing” or the like may be displayed. Or more simply, the parallel method may be shown with “P”, and the crossing method with “C”. Other than characters, the parallel method may be represented with a symbol “∥” and the crossing method with “X”. The character string as an indicator of a stereo image or the character string representing the classification of the creating method may be defined arbitrarily.

In the above way, synthesis of marks that permit the user to recognize makes it possible for the user to promptly know that the image is for 3D when the image is displayed on a 2D display. Further, clear expression of the creating method gives the advantage that the aforementioned 3D image that is displayed on a 2D display enables easy stereovision when the image is viewed with the naked eye. For performing stereovision, in the parallel method the image disposed on the left needs to be viewed with the left eye and the image on the right need to be viewed with the right eye, and in the crossing method the image disposed on the right needs to be viewed with the left eye and the image on the left need to be viewed with the right eye. Clearness of the image detecting method makes it possible to promptly determine which viewing method should be used.

3D information creating means 31 sends the 3D mark and parallax information to adjusting means 32. Positioning means 5 sends the information on the synthesized position of the 3D mark as the positional information to adjusting means 32. Adjusting means 32 determines the synthesized position based on the positional information and the parallax information.

Now, the determining method of the synthesized position will be described. Herein, description will made assuming that the image is compressed based on the JPEG scheme similarly to the above embodiment. As shown in FIGS. 7 and 8, in encoding the image is encoded every block of 8×8 pixels. This is called an encoding block. Upon performing image synthesis, if a 3D mark is synthesized such as to straddle the blocks, the high-frequency components of the image increase, so does the amount of codes. That is, there occurs the problem that if the amount of codes is kept constant, the image quality deteriorates. Accordingly, in order to prevent degradation of image quality as much as possible, adjusting means 32 is adapted to adjust the positions such that the boundaries of the blocks and the 3D mark coincide with each other.

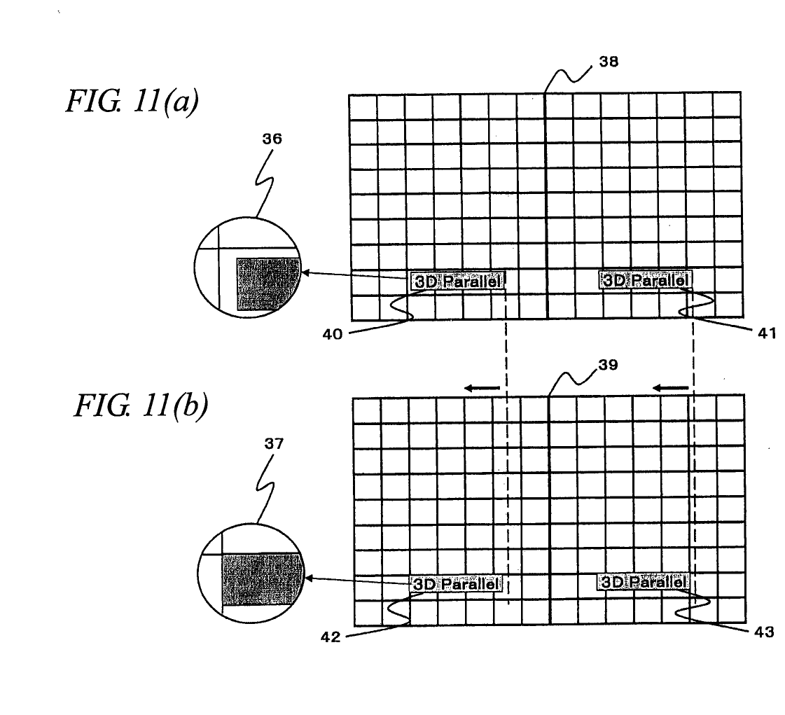

FIG. 11 is a diagram showing positioning adjustment of a 3D mark by adjusting means 32 from the position determined by positioning means 5. FIG. 11(a) shows a state before adjustment by adjusting means 32 and FIG. 11(b) shows a state after adjustment. The portions 36 and 37 encircled on the left side are enlarged views of the images showing the positional relationships between the 3D mark and the block. The center solid lines 38 and 39 divide the image into the left-eye image on the left side and the right-eye image on the right side, the squares represent encoding blocks.

As seen in the image of FIG. 11(a), the 3D marks are positioned by positioning means 5 so to have parallax. 3D mark 40 on the left-eye image is located more than two blocks rightwards from the left edge of the left-eye image whereas 3D mark 41 on the right-eye image is located less than two blocks away from center bold line 38 or the left edge of the right-eye image. When the 3D marks are arranged at the positions shown in the image of FIG. 11(a), both the left and right 3D marks 40 and 41 straddle encoding blocks, hence deterioration of image quality becomes greater. To deal with this, adjusting means 32 shifts 3D marks 40 and 41 so that either the upper edge or lower edge of 3D marks 40 and 41, which is closer to a block boundary in the original image, coincides with that block boundary. As to the left and right direction, the 3D marks are similarly shifted so that the mark boundary coincides with the block boundary to which the shifting distance of the mark is shortest. Thereby, the marks are rearranged as designated by 42 and 43 in the drawing of FIG. 11(b). The broken lines and arrows in FIG. 11 are drawn so as to show that the 3D marks have moved in their directions. This makes it possible to suppress deterioration of image quality during image synthesizing.

In the above example, the 3D marks are shifted so that the shifted distances of the 3D marks from the positions determined by positioning means 5 become minimum. However, in the state where the 3D marks are arranged by the positional information from positioning means 5 in accordance with the parallax of the overlap areas in the original image, and in the state where the original image forms an image that appears in front of the display screen, if the 3D marks are shifted in the shortest distances, there occur cases where the amount of parallax between the 3D marks becomes smaller than the amount of parallax between the overlapped areas of the original image, hence the resultant 3D mark appears to be somehow sunken. As described above, when it is sunken to the interior relative to the surroundings, it causes uncomfortable feeling. Accordingly, in such a case, the 3D marks are moved in directions such that the amount of parallax between the 3D marks becomes greater.

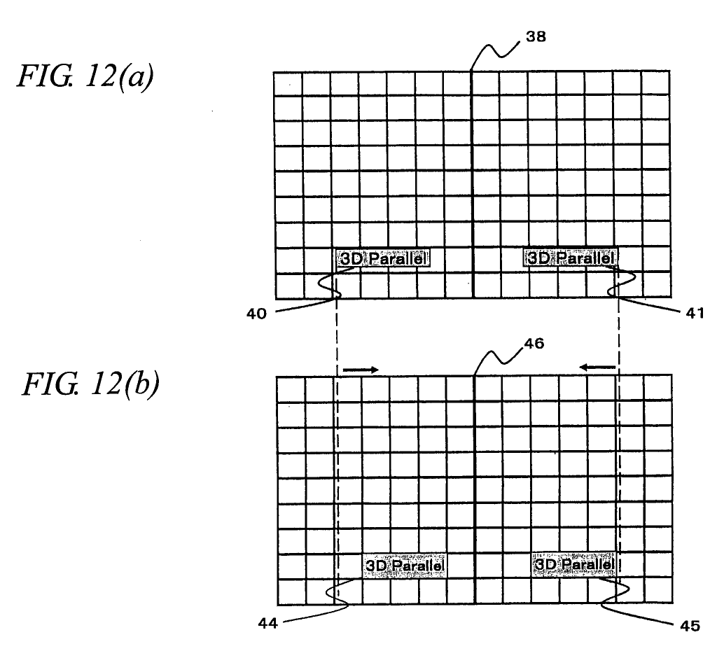

Further, there is a high possibility that just aligning only one of the upper and lower edges of the 3D marks and one of left and right edges with the block boundary does not match the other boundaries of the marks than those aligned with the block boundary, as is clear from FIG. 11. To deal with this, as shown in FIG. 12, in position adjustment of 3D marks, adjusting means 32 first shifts the 3D marks to the closest block boundaries in the directions to increase the amount of parallax, so as to eliminate uncomfortable feeling when it is viewed in stereovision. Then, 3D marks are automatically enlarged or reduced so that their size coincides with an integer multiple of the block, whereby all the boundaries will coincide with the block boundaries.

FIG. 12(a) shows a state before shift of 3D marks and FIG. 12(b) shows a state after shift and enlargement or reduction, where 3D mark 44 in the left-eye image is moved to the right and 3D mark 45 in the right-eye image is moved to the left to increase the amount of parallax. Further, the marks are reduced in the horizontal direction and enlarged in the vertical direction so as to adjust the block size to be integer multiples of the block size.

The image data thus synthesized is sent from image synthesizing means 33 to encoding means 6. As described above, the image of the present embodiment is assumed to be JPEG, similarly to embodiment 1, hence encoding is carried in the same flow shown in FIG. 8. Since the synthesized 3D marks are positioned so as to match the encoding block boundaries by means of adjusting means 32, deterioration of image quality at encoding is suppressed.

The encoded data is transferred from encoding means 6 to multiplexing means 34, where it is multiplexed with 3D information and outputted as multiplexed data.

Here, in the present embodiment, the size of the image, the block, etc., were described using figures different from the actual sizes for easy understanding. The image size may take any size such as 640×480, 1600×1200 etc. Also, here the image is assumed to be a still image, it is possible to handle motion pictures that are compressed by encoding such as MPEG (Moving Picture Experts Group)1, MPEG2, or the like.

Further, though the unit encoding block was assumed to be 8×8 pixels for JPEG, the unit should not be limited to this size of pixels, and any size may be accepted such as 16×16, if MPEG2 is used, and others.

Also, though the synthesized positions of both the left and right 3D marks are determined by positioning means 5, it is possible to provide a configuration that the positioning means sets rough positions only, and adjusting means 32 automatically sets the parallax in accordance with the background based on the parallax map as the parallax information.

Further, though, herein, the parallax is increased to align the objects to the boundaries of the encoding blocks when the object is overlapped over the image that appears in front of the display screen, the objects may be aligned to the boundaries such that the parallax is decreased and at the same time the transparency may be set up as in embodiment 1, whereby it is possible to suppress deterioration of image quality and reduce uncomfortable feeling. The shift and the enlarging and reducing process of the objects herein is performed by shifting first then enlargement or reduction, but the order may be reversed.

Also, the description of the present invention was made taking an example of a binocular method or the parallax barrier scheme, as the technique for stereoscopic display, other display techniques may be used.

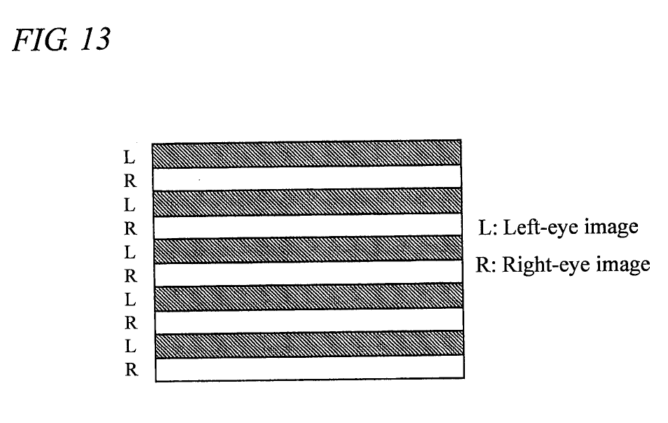

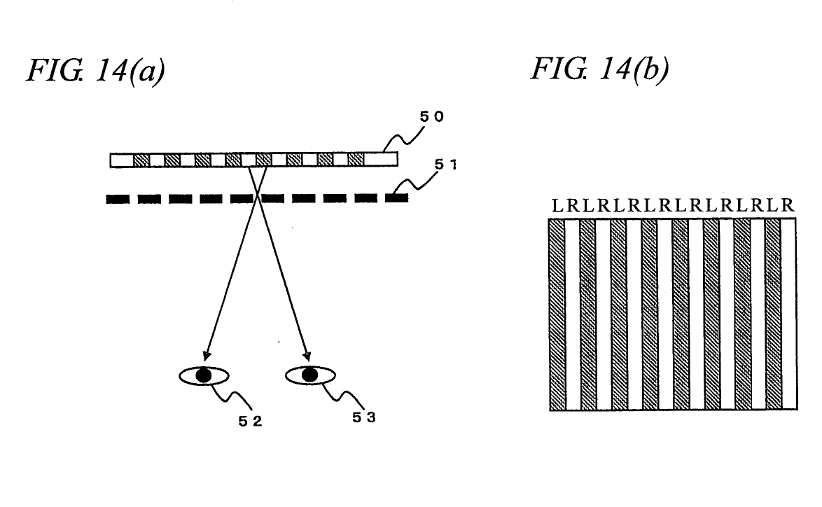

For example, time-division display technique, which is also one of the binocular methods, may be used. When this technique is applied, the left-eye image and right-eye image shown in FIGS. 15(a) and 15(b) are used in a format in which one pixel horizontal strips are arranged in a manner shown in FIG. 13, and this is displayed in a stereoscopic vision on a 3D display device such as a projector etc., that supports the time division display scheme. When the image is observed through liquid crystal shutter glasses having a shutter that open and close in synchronization with the reproduction timing of the 3D display device, the left-eye image can be viewed for a certain period and then the right-eye image can be viewed for a next certain period, thus the viewer can observe it as a stereo image.

Moreover, other than the binocular methods described herein, the multi-view display scheme or integral photographic scheme, which produces stereovision using preparatory images corresponding to a greater number of viewpoints, may be acceptable. Following to each scheme, various types of 3D image formats may be used instead of the two types presented herein.

The present invention should not be limited to the above described embodiments, and various changes can be made within the scope of claims, and any appropriate combinations of the technical means disclosed in different embodiments can be included in the technical scope of the present invention.

### INDUSTRIAL APPLICABILITY

As described heretofore, according to the image processing device of the present invention, when an object is synthesized into a 3D image, the transparency etc. of the object is determined taking the parallax of the 3D image into account, so that it is possible to realize a synthesized image free from uncomfortable feeling resulting from synthesis and to adjust the synthesized position of the object in order to reduce deterioration of the image quality at block encoding.

1. An image processing device for creating stereo image data composed of a plurality of images corresponding to a plurality of viewpoints, comprising:
an image synthesizing means for synthesizing an object into the stereo image data; and
a transparency determining means for designating a transparency of the object,
wherein the transparency determining means determines the transparency of the object based on parallax information between the plurality of images corresponding to the plurality of viewpoints.

2. The image processing device according to claim 1, wherein the transparency determining means acquires, as the parallax information, a parallax between areas in the plurality of images corresponding to the plurality of viewpoints, into which the object is synthesized, and sets the transparency of the object based on the parallax information.

3. The image processing device according to claim 1, wherein the transparency determining means takes a difference value between the amount of parallax between the areas in the images into which the object is synthesized and the amount of parallax as to the object, and determines the transparency based on the difference value.

4. The image processing device according to claim 1, further comprising: a positioning means for determining a position of the object, wherein the positioning means detects an occlusion area where no corresponding point exists based on the parallax information on the images and determines the position of the object so that the object overlaps the occlusion area.

5. The image processing device according to claim 1, wherein the image synthesizing means, based on the parallax information on the areas in the images into which the object is synthesized, synthesizes the object to each of the images in such a manner that the amount of parallax of the object becomes closest to the amount of parallax of the parallax information.

6. The image processing device according to claim 1, wherein the image synthesizing means, based on the parallax information on the areas in the images into which the object is synthesized, determines a horizontal position of the object such that the amount of parallax of the object is greater than the amount of parallax of the parallax information and a left edge of the object or a right edge of the object coincides with a boundary of encoding blocks.

7. The image processing device according to claim 1, wherein the image synthesizing means, when the object is synthesized into the images, synthesizes the object so that a lower or upper boundary of the object with respect to a vertical direction and a left or right boundary with respect to a horizontal direction coincide with boundaries of encoding blocks.

8. The image processing device according to claim 1, wherein both vertical and horizontal dimensions of the object are each equal to an integer multiple of the encoding block.

9. The image processing device according to claim 1, wherein the object is a visible, stereo image identification information that includes information indicating a stereo image.
